(19) United States
(12) Patent Application Publication
(10) Pub. No.: US 2023/0042086 A1
(43) Pub. Date: Feb. 9, 2023

(54) COMPOSITIONS FOR CONTROLLING ARTHROPODS

(71) Applicant: The Procter & Gamble Company, Cincinnati, OH (US)

(72) Inventors: Jonathan Javier CALDERAS, Cincinnati, OH (US); Michael D. MUI, Mason, OH (US)

(21) Appl. No.: 17/865,943

(22) Filed: Jul. 15, 2022

Related U.S. Application Data
(60) Provisional application No. 63/224,966, filed on Jul. 23, 2021.

(51) Int. Cl. A01N 65/22; A01N 25/04; A01N 65/44; A01N 65/06; A01P 7/00

(52) U.S. Cl. CPC A01N 65/22; A01N 25/04; A01N 65/44; A01N 65/06; A01P 7/00

(57) ABSTRACT

The present disclosure relates to pesticidal compositions and to methods for controlling pests, such as insects and other arthropods. More particularly, the disclosure relates to a pesticidal composition that leaves less residue on a treated surface, while providing efficacious control of arthropods.

### FIELD OF THE INVENTION

The present disclosure relates to pesticidal compositions and to methods for controlling pests, such as insects and other arthropods. More particularly, the disclosure relates to a pesticidal composition that leaves less residue on a treated surface, while providing efficacious control of arthropods.

### BACKGROUND OF THE INVENTION

Insects and other arthropod pests can have negative effects on the quality of human life. For instance, when found in the home, insects and other arthropods can be a source of annoyance due purely to their presence. They may also spread disease and allergens. For example, domestic cockroaches produce allergens in their saliva that may be problematic for people suffering from allergies. It is also desirable to control other crawling arthropods, such as ants, beetles, earwigs, silverfish, crickets, spiders, centipedes and various flying insects including flies, mosquitoes, gnats, moths, wasps, hornets, bees, and the like.

A number of arthropod pest control products exist today to control various arthropod pests, such as roaches, ants, flies, and gnats, both outside and inside the home. And, the market for arthropod pest control products is growing, due to factors such as an increase in urban housing, a growing consumer awareness concerning health and hygiene, and changes in weather patterns. At the same time, there is increasing consumer demand for arthropod pest control products that are more renewable or natural. Consumers also prefer pest control products that contain a limited number of ingredients and/or recognizable ingredients, as communicated by simpler ingredient statements. However, these products are still expected to be efficacious and efficiently kill arthropod pests, comparable to traditional pest control products.

There are existing arthropod pest control products that contain natural ingredients, such as plant essential oils. However, these existing products have a number of disadvantages: some products may be messy to use and/or may leave a residue on a treated surface; some products may be unstable at cold temperatures (i.e., about 5° C. to 10° C.) or separate into multiple phases and require a consumer to vigorously shake the product before use; some products are not recommended for use on food contact surfaces, and some products have limited efficacy. Other products do not provide an optimal scent experience, e.g., emit a long-lasting, unpleasant odor. Still other products do not provide optimal aesthetics, e.g., appear cloudy, or turbid, and/or off color. Therefore, there is a need for effective arthropod pest control compositions that contain fewer and/or natural ingredients, are less messy to use (e.g., reduced residue), can be used on food contact surfaces, provide improved aesthetics, and/or provide an improved scent experience.

### SUMMARY OF THE INVENTION

A pesticidal composition comprising:
a. from about 40% to about 95% by weight of the composition of water;
b. from about 0.01% to about 15% by weight of the composition of potassium oleate;
c. from about 1% to about 45% by weight of the composition of isopropyl alcohol;
d. optionally, from about 0.01% to about 15% by weight of the composition of sodium bicarbonate; and
e. optionally, from about 0.01% to about 1% by weight of the composition of citric acid anhydrous, citric acid monohydrate, or a combination thereof;
f. from about 1% to about 15% by weight of the composition of one or more active ingredients selected from the group consisting of corn mint oil, peppermint oil, spearmint oil, rosemary oil, thyme oil, citronella oil, clove oil, cedarwood oil, cinnamon oil, geranium oil, eugenol, 2-phenylethyl propionate, menthol, menthone, thymol, carvone, camphor, methyl salicylate, p-cymene, linalool, geraniol, cinnamyl acetate, cinnamic alcohol, cinnamaldehyde, citronellol, eucalyptol/1,8-cineole, alpha-pinene, bornyl acetate, gamma-terpinene, and combinations thereof;
wherein the composition has a pH of from about 4.5 to about 11.0.

### DETAILED DESCRIPTION OF THE INVENTION

Consumers are looking for effective and natural ways to control a variety of arthropods. However, existing arthropod pest control products that contain natural ingredients are often messy to use, unstable, and/or provide an unpleasant consumer experience, such as by requiring a consumer to shake the product before use and/or by appearing off color. Described herein is a substantially clear, substantially colorless, and stable (preferably not requiring shaking before use) aqueous pesticidal composition and is efficacious against arthropod pests. As used herein, “stable” refers to a pesticidal composition that is substantially clear and free from phase separation or precipitation, where no agitation or mixing is required to use the pesticidal composition for its application. The aqueous pesticidal compositions described herein are less messy to use, easy to clean up, and have acceptable product scent, aesthetics, or other characteristics, e.g., can be used on food contact surfaces.

Features and benefits of the various embodiments of the present invention will become apparent from the following description, which includes examples of specific embodiments intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, articles such as “a” and “an” when used in a claim, are understood to mean one or more of what is claimed or described.

As used herein, the terms “include”, “includes” and “including” are meant to be nonlimiting.

The term “renewable” is synonymous with the terms “natural,” “bio-derived”, “bio-based,” and means that a material is derived from substances derived from living organisms, such as farmed plants, rather than, for example, geologically derived, e.g., coal-derived or petroleum-derived.

“Geologically derived” means derived from, for example, petrochemicals, natural gas, or coal. “Geologically derived” materials cannot be easily replenished or regrown (e.g., in contrast to plant- or algae-produced materials).

As used herein, the term “renewable component” refers to a component that is derived from renewable feedstock and contains renewable carbon. A renewable feedstock is a feedstock that is derived from a renewable resource, e.g., plants, and non-geologically derived. A material may be partially renewable (less than 100% renewable carbon content, from about 1% to about 90% renewable carbon content, or from about 1% to about 80% renewable carbon content, or from about 1% to about 60% renewable carbon content, or from about 1% to about 50% renewable carbon content) or 100% renewable (100% renewable carbon content). A renewable feedstock may be blended or chemically reacted with a geologically derived feedstock, resulting in a material with a renewable component and a geologically derived component.

“Renewable carbon” may be assessed using the “Assessment of the Biobased Content of Materials” method, ASTM D6866-16.

As used herein, the term “natural oils” means oils that are derived from plant or algae matter (also referred to as renewable oils). Natural oils are not based on kerosene or other fossil fuels. The term “oils” include fats, fatty acids, waste fats, oils, or mixtures thereof. A natural oil typically includes triglycerides, free fatty acids, or a combination of triglycerides and free fatty acids, and other trace compounds.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, less than about 0.25%, less than about 0.1%, less than about 0.05%, or less than about 0.01% by weight of the composition, of the component.

As used herein the term “dye” includes aesthetic dyes that modify the aesthetics of the arthropod pest control composition. Dyes include colorants and pigments.

Volatile Organic Compounds (VOCs) are identified by the U.S. Environmental Protection Agency (EPA) as organic compounds that participate in atmospheric photochemical reactions, with the exception of compounds that have negligible photochemical reactivity. VOCs are generally emitted as gases from certain solids or liquids. Pesticides may be formulated to contain 40% by weight VOC, or less. The VOC level may be from about 1 wt. % to about 35 wt. %, or from about 2 wt. % to 20 wt. %.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Arthropod Pest Control Composition

The arthropod pest control compositions are preferably in the form of liquids. The arthropod pest control compositions are preferably aqueous compositions. Aqueous liquid compositions are convenient to use because these compositions can be readily applied directly to arthropod pests, without leaving residue on adjacent surfaces. The arthropod pest control composition may comprise from about 40% to about 95%, or from about 50% to about to about 90%, or from about 55% to about 80%, or from about 58% to about 78%, or from about 60% to about 75%, or from about 62% to about 72% by weight of the total composition of water. The arthropod pest control compositions may be clear, as clarity may connote purity to the user. The arthropod pest control compositions may be provided in the form of a ready-to-use composition, which can be directly applied to arthropod pests (e.g., as a spray) and need not be diluted by a consumer before use. Ready-to-use compositions may be preferred by some consumers, because ready-to-use compositions do not require dilution by the consumer, which may be messy, inconvenient, and/or require multiple containers. The arthropod pest control compositions disclosed herein may contain select ingredients at select levels suitable to be sprayed directly onto arthropod pests.

The arthropod pest control compositions disclosed herein may be substantially free of geologically derived (e.g., petroleum-based) oils, such as mineral oil, as products containing mineral oil may be messy to use and may leave a residue on a treated surface.

The pH of the arthropod pest control composition may be from about 4.5 to about 11.0, preferably from about 7.0 to about 9.0, more preferably from about 7.5 to about 8.5. The pH of the composition may be adjusted using pH modifying ingredients known in the art.

The arthropod pest control compositions disclosed herein may have a relatively high level of clarity (i.e., low turbidity). Some consumers prefer a clear product versus a product that is cloudy or murky (i.e., higher turbidity). The compositions may exhibit a turbidity of less than about 20 NTU, preferably less than about 5 NTU, and greater than or equal to about 0 NTU. The compositions may exhibit a turbidity of from about 1 to about 10 NTU. Turbidity of the compositions is measured with a laboratory turbidity meter as described in the Test Methods section below.

The arthropod pest control compositions disclosed herein may have a reduced yellow color. Some consumers prefer a colorless or substantially colorless product versus a product that has a yellow color. Yellow color may be characteristic of the breakdown of certain active ingredients in the compositions, particularly the breakdown of plant oils, such as cornmint oil and rosemary oil. The reduction of the yellow color may be measured by any colorimetric or spectrometric method known in the art. Suitable colorimetric analytical methods include, for example, the Gardner color scale (according to American Society for Testing and Materials (“ASTM”) method ASTM D1544, D6166 and/or American Oil Chemists' Society (“AOCS”) method AOCS Td-1a-64); the CIELAB color scale (according to ASTM D5386-93b); the American Public Health Association (“APHA”) color scale (according to ASTM D1209 or AOCS Td-1b-64); the Saybolt color scale (according to ASTM D156 or D6045); or the Lovibond (red) scale (according to AOCS Cc-13b-45). The CIELAB color scale may be used to quantify the color of an arthropod pest control composition. The CIELAB color scale may also be referred to as L*a*b*, a color scale defined by the International Commission on Illumination (abbreviated CIE) in 1976. The CIELAB color scale expresses color as three values: L* for perceptual lightness, and a* and b* for the four unique colors of human vision: red, green, blue, and yellow, where the b* value represents blue/yellow color. It should be noted that the present disclosure is not limited to any specific colorimetric measurement and the reduction of the yellow color observed may be measured by any suitable colorimetric method.

The arthropod pest control compositions of the present disclosure may comprise renewable components and exhibit good efficacy against arthropod pests. The compositions disclosed herein may comprise from about 1%, or from about 5%, or from about 10%, or from about 20% or from about 30%, of from about 40% or from about 50%, to about 40%, or to about 50%, or to about 60% or to about 70% or to about 80% or to about 90%, or to about 100% by weight of renewable components. The compositions disclosed herein may be at least partially or fully bio-based, As such, the composition can comprise a bio-based carbon content of about 50% to about 100%, preferably about 70% to about 100%, more preferably about 75% to about 100%, even more preferably about 80% to about 100%, most preferably about 90% to about 100%. The percent bio-based carbon content can be calculated as the “percent Modern Carbon (pMC)” as derived using the methodology of ASTM D6866-16. The compositions of the present disclosure may be substantially free of petroleum-derived solvents or petroleum-derived surfactants.

The compositions disclosed herein may comprise less than about 15 ingredients, preferably less than about 10 ingredients, more preferably less than about 15 ingredients and greater than about 5 ingredients.

The compositions disclosed herein may comprise ingredients listed under section 25(b) of the Federal Insecticide, Fungicide, and Rodenticide Act (FIFRA), incorporated herein by reference in its entirety. The compositions disclosed herein may comprise naturally occurring compounds or extracts or derivatives thereof. The compositions disclosed herein may comprise at least one organic, certified organic, US Department of Agriculture (“USDA”) National Organic Program compliant (“NOP-compliant”) ingredient. The compositions disclosed herein may comprise at least one ingredient that is food grade or generally recognized as safe (GRAS). The GRAS ingredient may include any agent listed on the FDA's GRAS list, including direct food additives (see, e.g., US law (sections 201(s) and 409 of the Federal Food, Drug, and Cosmetic Act, November 2016). The GRAS ingredient may also include, but is not limited to, agents that are generally recognized, among experts qualified by scientific training and experience to evaluate their safety, as having been adequately shown through scientific procedures (or, in the case of a substance used in food prior to Jan. 1, 1958, through either scientific procedures or through experience based on common use in food) to be safe. The use of food grade or GRAS ingredients enables the compositions disclosed herein to be used by consumers without rinsing a treated surface after use. The compositions disclosed herein may comprise ingredients that have a tolerance or tolerance exemption for use on food contact surfaces under the Federal Food, Drug, and Cosmetic Act US law (see, e.g., 40 CFR 180, November 2016, December 2015 update).

Active Ingredients

The arthropod pest control composition may comprise one or more active ingredients (also referred to herein as actives). The arthropod pest control composition may comprise from about 0.005% to about 15%, or from about 0.05% to about 12%, or from about 0.5% to about 10%, or from about 1% to about 7%, or from about 1.00% to about 15% of the composition of one or more active ingredients.

Nonlimiting examples of active ingredients include aldehyde C16 (pure), almond oil, terpenes, alpha-terpineol, verbenone, alpha-cedrene, cinnamic aldehyde, amyl cinnamic aldehyde, cinnamyl acetate, amyl salicylate, anisic aldehyde, citric acid, cedrol, benzyl alcohol, benzyl acetate, cinnamaldehyde, cinnamic alcohol, carvacrol, caryophyllene, carveol, citral, citronellal, methylheptenone, citronellol, dimethyl salicylate, eucalyptol (also known as 1,8-cineole), thujopsene, 3-thujopsanone, α-thujone, β-thujone, fenchone, eugenyl acetate (e.g., isoeugenyl acetate), eugenol, iso-eugenol, methyl iso-eugenol, galaxolide, geraniol, guaiadiene, guaiacol, ionone, menthol (e.g., L-menthol), menthyl ester, menthone, carvone (e.g., L-carvone), camphor, camphene, p-cymene, borneol, bornyl esters, bornyl acetate, isobornyl acetate, terpinene (e.g., gamma-terpinene), methyl anthranilate, methyl ionone, methyl salicylate, nerol, phellandrene (e.g., alpha-phellandrene), pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, myrcene, chavicol, acetaldehyde, safrole, terpinen-4-ol, cineole, dimethyl trisulfide, diallyl disulfide, diallyl sulfide, diallyl tetrasulfide, 3-vinyl-[4H]-1,2-dithiin, thyme oil, thyme oil white, thyme oil red, thymol, anethole (e.g., trans-anethole), vanillin, ethyl vanillin, castor oil, cedar oil, cedarwood oil, cinnamon, cinnamon oil, citronella, citronella oil, clove, clove oil, corn oil, corn mint oil, oregano oil, cottonseed oil, garlic, garlic oil, geranium oil, lemongrass oil, linseed oil, mint, mint oil, peppermint, peppermint oil, spearmint, rose oil, spearmint oil, rosemary, rosemary oil, sesame, sesame oil, soybean oil, white pepper, licorice oil, wintergreen oil, anise oil (e.g., star anise oil), lilac flower oil, black seed oil, bay oil, grapefruit seed oil, grapefruit, lemon oil, orange oil, orange flower oil, tea tree oil, cedar leaf oil, camphor oil, Tagete minuta oil, lavender oil, Lippia javancia oil, oil of bergamot, galbanum oil, eucalyptus oil, lovage oil, and mixtures thereof.

The arthropod pest control composition may comprise one or more active ingredients selected from the group consisting of essential plant oils (including synthetic analogues), eugenol, 2-phenylethyl propionate, amyl butyrate, geraniol, limonene (e.g., d-limonene), linalool, methyl salicylate, pinene (e.g., alpha-pinene, beta-pinene), piperonal, piperonyl alcohol, tetrahydrolinalool, thymol, vanillin, ethyl vanillin, iso-eugenol, ethyl cinnamate, pyrethrins, abamectin, azadirachtin, amitraz, rotenone, boric acid, spinosad, biopesticides, synthetic pesticides, and mixtures thereof.

The arthropod pest control composition may comprise an active ingredient selected from the group consisting of eugenol, 2-phenylethyl propionate, menthol, menthone, thymol, carvone (e.g., L-carvone), camphor, methyl salicylate, p-cymene, linalool, linalyl acetate, eucalyptol, alpha-pinene, bornyl acetate, isobornyl acetate, gamma-terpinene, cinnamyl acetate, cinnamic alcohol, cinnamaldehyde, and combinations thereof. The arthropod pest control composition may comprise an essential plant oil, such as corn mint oil, peppermint oil, spearmint oil, rosemary oil, thyme oil, citronella oil, clove oil, and cedarwood oil.

The arthropod pest control composition may comprise from about 0.005% to about 15%, or from about 0.05% to about 12%, or from about 0.5% to about 10%, or from about 1% to about 7%, or from about 1% to about 15% by weight of the composition of one or more active ingredients, wherein the active ingredient is an essential plant oil. The arthropod pest control composition may comprise one or more essential plant oils selected from the group consisting of corn mint oil, peppermint oil, spearmint oil, rosemary oil, thyme oil, citronella oil, clove oil, cedarwood oil, and mixtures thereof, preferably selected from the group consisting of corn mint oil, spearmint oil, rosemary oil, thyme oil, and mixtures thereof, more preferably selected from the group consisting of corn mint oil, rosemary oil, and combinations thereof.

The arthropod pest control compositions described herein may comprise from about 0.01% to about 1%, preferably about 0.01% to about 0.8%, more preferably about 0.01% to about 0.6%, by weight of the composition of citric acid or a salt thereof, preferably citric acid anhydrous or citric acid monohydrate. The compositions described herein may comprise from about 0.01% to about 1% by weight of the composition of citric acid or a salt thereof, such as potassium citrate, monopotassium citrate, tripotassium citrate, tripotassium citrate monohydrate, or dipotassium citrate. Citric acid may also function to adjust the pH of the composition and/or as a chelant.

The arthropod pest control composition may comprise one or more synthetic pesticides. Nonlimiting examples of synthetic pesticides include pyrethroids, such as bifenthrin, esfenvalerate, fenpropathrin, permethrin, cypermethrin, cyfluthrin, deltamethrin, allethrin, lambda-cyhalothrin, or the like; syngergists, such as piperonyl butoxide, or the like; juvenile hormone analogues, such as methoprene, hydroprene, kinoprene, or the like; and neonicotinoids, such as imidacloprid, acetamiprid, thiamethoxam, or the like, and mixtures thereof. The arthropod pest control composition may comprise less than about 10%, or less than about 5%, or less than about 2%, or less than about 1%, or less than about 0.5%, or less than about 0.1% by weight synthetic pesticide. Alternatively, the arthropod pest control composition may be substantially free of synthetic pesticide.

The arthropod pest control composition may comprise one or more biopesticides. Nonlimiting examples of biopesticides include pyrethrum, rotenone, neem oil, and mixtures thereof.

Fatty Acid/Fatty Acid Salt (Soap)

The arthropod pest control composition disclosed herein may be formulated with one or more fatty acids or salts thereof. The pest control composition may comprise from about 0.01% to about 15%, or from about 0.1% to about 10%, or from about 1% to about 5% of one or more fatty acids or salts thereof.

A sprayed drop of a pesticidal composition comprising an active agent is preferably able to wet a target surface and spread out or cover a target area to perform its intended function. A fatty acid or salt thereof generally reduces the surface tension of the water on the surface of the spray drop by reducing the interfacial tension between the spray drop and target surface, e.g., exoskeleton of an arthropod. Fatty acids or salts thereof also wet and disperse particles of active ingredient(s) in the composition prior to spraying, thereby enabling more uniform coverage and wetting of the target arthropod upon spraying. Fatty acids or salts thereof may also function to emulsify active agents that are not easily solubilized in water, such as oils.

Fatty acids and salts thereof are organic molecules comprising a single carboxylic acid moiety (carboxylate anion in salts) and at least 7 carbon atoms, or from about 11 to about 22 carbon atoms, or from about 12 to about 16 carbon atoms. Fatty acids or salts thereof are considered anionic surfactants and contain a long chain hydrocarbon hydrophobic group in their molecular structure and a hydrophilic group, namely carboxylic acid/carboxylate. The salts may be sodium, potassium, calcium, magnesium, barium, iron, ammonium and amine salts of fatty acids. The salts of fatty acids are also known as soaps. Fatty acid and the salts thereof may be linear, branched, saturated, unsaturated, cyclic, or mixtures thereof. Nonlimiting examples of fatty acids and salts thereof include lauric acid, myristic acid, palmitic acid, stearic acid, arachidic acid, behenic acid, lignoceric acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, docosahexaenoic acid, the sodium, calcium, potassium or zinc salts thereof, or mixtures thereof. A preferred fatty acid soap is an alkali metal salt of oleate, preferably sodium oleate or potassium oleate, more preferably sodium oleate. The arthropod pest control composition may comprise from about 0.01% to about 15%, or from about 0.1% t to about 10%, or from about 1% to about 5% by weight of a fatty acid or salt thereof. The arthropod pest control composition may comprise from about 0.01% to about 15%, or from about 0.1% t to about 10%, or from about 1% to about 5% by weight of potassium oleate.

Additional Surfactant

The arthropod pest control compositions of the present disclosure may comprise an additional anionic surfactant and/or one or more surfactants selected from the group consisting of amphoteric surfactants, zwitterionic surfactants, nonionic surfactants, cationic surfactants, and mixtures thereof. Suitable additional anionic surfactants include alkyl sulfates and alkali metal salts thereof (e.g., sodium dodecyl/lauryl sulfate). Alternatively, the arthropod pest control compositions may be substantially free of sodium lauryl sulfate.

Solvent

The arthropod pest control compositions described herein may comprise from about 1% to about 45%, or from about 1% to about 30%, or from about 1% to about 25%, or from about 1% to about 15% by weight the composition of one or more solvents. Liquid arthropod pest control compositions may contain one or more solvents and water.

Suitable solvents include alcohols, such as monohydridic or polyhydridic alcohols. Preferred alcohols are low molecular weight primary or secondary alcohols exemplified by ethanol, propanol, and isopropanol, preferably isopropanol. Monohydric alcohols and polyols, such as those containing from 2 to about 6 carbon atoms and from 2 to about 6 hydroxy groups (e.g., ethylene glycol, glycerine, and 1,2-propanediol (also referred to as propylene glycol)), may also be used.

Suitable solvents also include esters. The arthropod pest control composition may comprise from about 0.005% to about 15%, or from about 0.05% to about 12%, or from about 0.5% to about 10%, or from about 1% to about 7% by weight of the composition of one or more esters. Esters are commonly formed by reacting a carboxylic acid with a molecule comprising one or more hydroxyl groups. Examples of suitable carboxylic acids include acetic acid, formic acid, lactic acid, citric acid, malic acid, oxalic acid, propanoic acid, propiolic acid, butyric acid, isobutryic acid, caproic acid, adipic acid, benzoic acid, salicylic acid, caprylic acid and fatty acids. Nonlimiting examples of molecules comprising one or more hydroxyl groups include methanol, ethanol, sorbitol, propyl alcohol, isopropyl alcohol, butyl alcohol, sec-butyl alcohol, isobutyl alcohol, tert-butyl alcohol, ethylene glycol, propylene glycol, glycerol, polyglycerol, cyclohexanol, and benzyl alcohol. Examples of suitable esters include isopropyl myristate, myristyl myristate, isopropyl palmitate, octyl palmitate, isopropyl isothermal, butyl lactate, ethyl lactate, butyl stearate, triethyl citrate, glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, decyl oleate, glyceryl stearate, isocetyl stearate, octyl stearate, putty stearate, isostearyl neopentonate, PPG myristyl propionate, diglyceryl monooleate, and diglyceryl monostearate. The arthropod pest control composition may comprise ethyl lactate, preferably from about 0.005% to about 15%, or from about 0.05% to about 12%, or from about 0.5% to about 10%, or from about 1% to about 7% by weight of the composition of ethyl lactate.

Additional solvents include lipophilic fluids, including siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, and mixtures thereof.

Suitable solvents listed under section 25(b) of the Federal Insecticide, Fungicide, and Rodenticide Act (FIFRA) include butyl lactate (including enantiomers thereof), vinegar, 1,2-propylene carbonate, isopropyl myristate, ethyl lactate (including enantiomers thereof), and glycerine.

Preferred solvents include isopropanol, ethanol, glycerine, ethyl lactate, renewable versions thereof, and mixtures thereof. The arthropod pest control compositions described herein may comprise from about 1% to about 45%, or from about 1% to about 30%, or from about 1% to about 25%, or from about 1% to about 15% by weight the composition of a solvent selected from the group consisting of isopropanol, glycerine, ethyl lactate, and mixtures thereof.

Bicarbonate

The arthropod pest control composition may comprise bicarbonate, preferably a bicarbonate inorganic salt, more preferably sodium bicarbonate. The arthropod pest control composition may comprise from about 0.01% to about 15%, preferably about 0.1% to about 8%, more preferably about 0.4% to about 4% by weight of the composition of a bicarbonate, preferably sodium bicarbonate.

Polysaccharide Gums

The arthropod pest control compositions disclosed herein may comprise a polysaccharide gum. Suitable polysaccharide gums include xanthan gum, guar gum, gum Arabic, cellulose, and cellulose derivatives. The arthropod pest control compositions disclosed herein may comprise xanthan gum. The arthropod pest control compositions of the present disclosure may comprise from about 0.1% to about 7.5%, or from about 0.5% to about 4.5%, or from about 0.1% to about 2.3% by weight of the composition of a polysaccharide gum, preferably xanthan gum.

Preservatives

The arthropod pest control compositions disclosed herein may comprise one or more preservatives. As used herein a “preservative” is any substance or compound that is added to protect against decay, decomposition, or spoilage. Preservatives may be natural or synthetic. Preservatives may be antimicrobial preservatives, which inhibit the growth of bacteria or fungi, including mold, or antioxidants. Nonlimiting examples of preservatives include potassium sorbate, tocopherol (e.g., tocopherol acetate), calcium propionate, sodium nitrate, sodium nitrite, sulfites (sulfur dioxide, sodium bisulfite, potassium hydrogen sulfite, etc.), and disodium EDTA. The arthropod pest control compositions disclosed herein may comprise from about 0.02% to about 4% by weight of the composition of a preservative, preferably a preservative selected from the group consisting of potassium sorbate, tocopherol, and mixtures thereof.

Dye

The arthropod pest control composition may comprise a dye or colorant. Nonlimiting examples of colorants include inorganic pigments, such as ultramarine blue, organic dyes, and trace nutrients, such as salts of iron, manganese, boron, copper, cobalt, molybdenum and zinc. Colorants may be included to modify the aesthetics of the arthropod pest control compositions. The compositions disclosed herein may comprise from about 0.001% to about 0.1%, preferably 0.005% to about 0.05%, more preferably 0.008% to about 0.02% by weight of the composition of a dye or colorant.

### Combinations

A. A pesticidal composition comprising: a. from about 40% to about 95%, preferably from about 50% to about to about 90%, more preferably from about 55% to about 80%, even more preferably from about 58% to about 78%, even more preferably from about 60% to about 75%, most preferably from about 62% to about 72%, by weight of the composition of water; b. from about 0.01% to about 15%, preferably from about 0.1% to about 10%, or from about 1% to about 5%, by weight of the composition of potassium oleate; c. from about 1% to about 45%, preferably from about 1% to about 30%, more preferably from about 1% to about 25%, even more preferably from about 1% to about 15%, by weight of the composition of isopropyl alcohol; d. optionally, from about 0.01% to about 15%, preferably from about 0.1% to about 8%, more preferably from about 0.4% to about 4%, by weight of the composition of sodium bicarbonate; and e. optionally, from about 0.01% to about 1%, preferably from about 0.01% to about 0.8%, more preferably from about 0.01% to about 0.6%, by weight of the composition of citric acid anhydrous, citric acid monohydrate, or a combination thereof; f. from about 0.005% to about 15%, preferably from about 0.05% to about 12%, more preferably from about 0.5% to about 10%, even more preferably from about 1% to about 7%, by weight of the composition of one or more active ingredients selected from the group consisting of corn mint oil, peppermint oil, spearmint oil, rosemary oil, thyme oil, citronella oil, clove oil, cedarwood oil, and mixtures thereof, preferably selected from the group consisting of corn mint oil, spearmint oil, rosemary oil, thyme oil, and mixtures thereof, more preferably selected from the group consisting of corn mint oil, rosemary oil, and combinations thereof; where the composition has a pH of from about 4.5 to about 11.0, preferably from about 7.0 to about 9.0, more preferably from about 7.5 to about 8.5.
B. A pesticidal composition comprising: a. from about 40% to about 95%, preferably from about 50% to about to about 90%, more preferably from about 55% to about 80%, even more preferably from about 58% to about 78%, even more preferably from about 60% to about 75%, most preferably from about 62% to about 72%, by weight of the composition of water; b. from about 0.01% to about 15%, preferably from about 0.1% to about 10%, or from about 1% to about 5%, by weight of the composition of potassium oleate; c. from about 1% to about 45%, preferably from about 1% to about 30%, more preferably from about 1% to about 25%, even more preferably from about 1% to about 15%, by weight of the composition of isopropyl alcohol; d. optionally, from about 0.01% to about 15%, preferably from about 0.1% to about 8%, more preferably from about 0.4% to about 4%, by weight of the composition of sodium bicarbonate; and e. optionally, from about 0.01% to about 1%, preferably from about 0.01% to about 0.8%, more preferably from about 0.01% to about 0.6%, by weight of the composition of citric acid anhydrous, citric acid monohydrate, or a combination thereof; f. from about 0.005% to about 15%, preferably from about 0.05% to about 12%, more preferably from about 0.5% to about 10%, even more preferably from about 1% to about 7%, by weight of the composition of one or more active ingredients selected from the group consisting of eugenol, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and combinations thereof; where the composition has a pH of from about 4.5 to about 11.0, preferably from about 7.0 to about 9.0, more preferably from about 7.5 to about 8.5.
C. The pesticidal composition according to Paragraphs A or B, where the composition is clear.
D. The pesticidal composition according to any one of Paragraphs A-C, where the composition is an oil-in-water emulsion.
E. The pesticidal composition according to any one of Paragraphs A-D, where the composition is substantially free of sodium lauryl sulfate.
F. The pesticidal composition according to any one of Paragraphs A-E, where the composition is packaged in a clear container.
G. The pesticidal composition according to any one of Paragraphs A-F, where the composition further comprises from about 0.01% to about 0.5% of tocopherol.
H. The pesticidal composition according to any one of Paragraphs A-G, where the composition is substantially free of mineral oil.
I. The pesticidal composition according to any one of Paragraphs A-H, where the composition comprises only food grade ingredients.
J. The pesticidal composition according to any one of Paragraphs A-I, where the composition comprises from about 0.5% to about 7%, preferably about 0.5% to about 5%, more preferably about 0.5% to about 4% by weight of the composition of rosemary oil.
K. The pesticidal composition according to any one of Paragraphs A-J, where the composition comprises from about 0.5% to about 7%, preferably about 0.5% to about 5%, more preferably about 0.5% to about 4% by weight of the composition of corn mint oil.
L. The pesticidal composition according to any one of Paragraphs A-K, where the composition comprises from about 0.5% to about 7%, preferably about 0.5% to about 5%, more preferably about 0.5% to about 4% by weight of the composition of spearmint oil.
M. The pesticidal composition according to any one of Paragraphs A-L, where the composition comprises from about 0.5% to about 7%, preferably about 0.5% to about 5%, more preferably about 0.5% to about 4% by weight of the composition of thyme oil.
N. The pesticidal composition according to any one of Paragraphs A-M, where the composition comprises from about 0.5% to about 7%, preferably about 0.5% to about 5%, more preferably about 0.5% to about 4% by weight of the composition of citronella oil.
O. The pesticidal composition according to any one of Paragraphs A-N, where the composition comprises from about 0.5% to about 7%, preferably about 0.5% to about 5%, more preferably about 0.5% to about 4% by weight of the composition of cedarwood oil.
P. The pesticidal composition according to any one of Paragraphs A-O, where the composition further comprises from about 0.001% to about 1%, preferably from about 0.01% to about 1%, more preferably from about 0.1% to about 0.8% by weight of the composition of a colorant, preferably a colorant selected from the group consisting of ultramarine blue, red cabbage dye, beet dye, carrot dye, chlorophyll, and mixtures thereof.
Q. The pesticidal composition according to any one of Paragraphs A-P, where the composition further comprises from about 0.1% to about 7.5%, preferably from about 0.5% to about 4.5%, more preferably from about 0.1% to about 2.3% by weight of the composition of a polysaccharide, preferably xanthan gum.
R. The pesticidal composition according to any one of Paragraphs A-Q, where the composition has a turbidity less than about 20 NTU, preferably less than about 5 NTU, and greater than or equal to about 0 NTU.
S. The pesticidal composition according to any one of Paragraphs A-R, where the composition has a b* value of about 0 to about 4, preferably about 0 to about 2.
T. A method of controlling an arthropod pest comprising: i) contacting the arthropod pest with the pesticidal composition according to any one of Paragraphs A-S; ii) optionally, wiping excess composition from an adjacent surface.

Test Methods

Determination of the Hunter L.a.b. (CIE) b* Value

The formation of yellow color is measured using the Hunter L.a.b. (CIE) method. The b value is determined using a HunterLab ColorFlex EZ® spectrophotometer (HunterLab, 11491 Sunset Hills Road, Reston, Va. 20190). The methodology that is used is described in detail in the “User's Manual for ColorFlex EZ Version 2.2.” The average of four separate readings is reported.

The HunterLab ColorFlex EZ® spectrophotometer uses a xenon flash lamp to illuminate a sample. The light reflected from the sample is then separated into its component wavelengths through a dispersion grating. The relative intensities of the light at different wavelengths along the visible spectrum (400-700 nm) are then analyzed to produce a number result indicative of the color of the sample.

Turbidity

A turbidimeter is used to measure the turbidity of pesticidal compositions. This instrument measures the turbidity of liquids in Nephelometric Turbidity Units (NTU). The method of measuring turbidity is described in detail in the following reference: Hach 2100Q and 2100Qis User Manual, Edition 6, August 2021, from the Hach Company.

This method of measurement determines quantitative values of turbidity by evaluating the ratio of a primary nephelometric light scatter signal to a transmitted light scatter signal. This particular method of evaluation provides values between 0-1000 NTU, where increasing NTU values indicate more turbid compositions. In between each test sample, water controls may be measured to ensure proper equipment operation. For example, water may have a turbidity of about 1.11 NTU and isopropyl alcohol may have a turbidity of about 0.15 NTU. It is believed that improved emulsification of active ingredients, particularly hydrophobic active ingredients, yields lower NTU values.

Insect Testing

Materials:

The insects used in the testing are male German cockroaches (Blattella germanica) from Benzon Research, Inc., 7 Kuhn Dr, Carlisle, Pa. 17015. The insects are contained in clear PET cups (c-kc24) that are covered with clear PET flat lids (c-kc626ts) that have holes for straws (cups and lids are available from Karat). Spray bottles are clear PET bottles with 1.1% 66SA7600 antistatic additive (PMP-91690456) with Silgan Mixor MP 1.3CC sprayers (PMP-91690457). Additional materials used in the testing are filter paper, Ol' Roy™ dog food, and a Kuggis white box with lid (10¼×13¾×6) from IKEA (“test box”).

Method:

The cockroaches are first placed in a 4° C. refrigerator (in the containers that the cockroaches are received in) for 10 to 20 minutes for cold anesthetization. If the cockroaches are still active after 10 to 20 minutes of cold anesthetization, they are placed back into the 4° C. refrigerator for an additional 5 minutes, in order to reduce the activity of the cockroaches and facilitate sample cup preparation.

The insects are then relocated to a large, shallow plastic container that has a lid. The large plastic container is chilled on ice packs (by placing the plastic container directly on the ice packs) to keep the insects cold during allocation of the insects into individual cups. As the cockroaches begin to stir, the cockroaches that are moving the most are selected first for sorting into the prepped individual cups (5 insects per cup). The cockroaches are handled with soft tipped tweezers. Cockroaches that have leg movements are selected next.

Each sample cup is prepared by placing filter paper and one kibble of Ol' Roy™ dog food at the bottom of cup. The filter paper is sprayed with water, so that the cockroaches do not dehydrate overnight, and 5 cockroaches are placed in each cup. A lid is placed on each cup and the straw hole in each lid is taped.

After allocating the cockroaches, 5 per cup, the cups containing the insects are kept at room temperature to allow the insects to return to their normal activity level. Insect movement is checked and confirmed prior to each test. Only cups that contain 5 living insects are used for data gathering. Cups with fewer than 5 living insects may be used for informal screening or combined to make a sample of 5 living insects.

Testing:

Each spray bottle is primed prior to testing, by squeezing the trigger until a steady spray of product is achieved. The spray (versus stream) setting is used. Each cup is placed in the test box (Kuggis white box) and inverted in the approximate center of the test box (one sample cup at a time). The cup is then lifted and the cockroaches are sprayed 3 to 5 times, until each insect is visually determined to be wetted. A video of the testing is recorded.

Cockroach incapacitation and moribundity are recorded in the video. Incapacitation is defined herein as the inability of the cockroach to right itself or move in an upright, deliberate manner. Incapacitation does not exclude twitching of wings, legs, or antennae (in other words, an insect that exhibits twitching of wings, legs, or antennae is still deemed “knocked down” if it cannot right itself or move in an upright, deliberate manner). Moribundity or moribund refers to a condition where a cockroach is unable to right itself or move in an upright, deliberate manner and the cockroach does not exhibit any movement from its wings, legs, or antennae. Cockroach mortality refers to a condition where the cockroach does not move when subjected to external stimulus (e.g. prodding). Mortality is not measured or determined in the experiments described herein. Videos are reviewed and the time of incapacitation and moribundity are documented for each insect.

Each time of incapacitation and each time of moribundity documented in the tables below is the average of two test replicates, where each test replicate comprises 5 insects (per cup, as described above). Within each test replicate of 5 insects, time of incapacitation and time of moribundity is recorded for each of the 5 insects and the averages of the 5 incapacitation times and the 5 moribundity times are calculated. The average of the 5 incapacitation times for the first test replicate and the average of the 5 incapacitation times for the second test replicate are then averaged and documented in the tables below. The average of the 5 moribundity times for the first test replicate and the average of the 5 moribundity times for the second test replicate are then averaged and documented in the tables below. Also, for each test replicate, incapacitation times and moribundity times for insects that appear inadequately sprayed are excluded from the calculation of average incapacitation time and average moribundity time.

### EXAMPLES

### Example 1—Addition of Isopropanol Reduces Incapacitation and Moribundity Time

The pesticidal compositions in Table 1 are prepared by mixing the individual starting materials in a batch type process. The pesticidal composition of Examples 1 through 4 vary only in the concentrations of isopropyl alcohol and water. The results in Table 1 show that both incapacitation and moribundity time decrease as the concentration of isopropanol is increased.

TABLE 1

| Ingredient (weight | | | | |
|---|---|---|---|---|
| percent) | 1 | 2 | 3 | 4 |
| Potassium Oleate | 2.6 | 2.6 | 2.6 | 2.6 |
| Corn mint Oil | 0.55 | 0.55 | 0.55 | 0.55 |
| Citronella Oil | 1.88 | 1.88 | 1.88 | 1.88 |
| Rosemary Oil | 2.67 | 2.67 | 2.67 | 2.67 |
| Thyme Oil | 0.91 | 0.91 | 0.91 | 0.91 |
| Spearmint Oil | 0.06 | 0.06 | 0.06 | 0.06 |
| Cedarwood Oil Texas | 0.53 | 0.53 | 0.53 | 0.53 |
| Isopropyl Alcohol | 5.00 | 10.00 | 15.00 | 20.00 |
| Anhydrous | | | | |
| Glycerin | 2.50 | 2.50 | 2.50 | 2.50 |
| DI Water | 82.28 | 77.28 | 72.28 | 67.28 |
| Potassium Citrate | 0.92 | 0.92 | 0.92 | 0.92 |
| Incapacitation | 22.80 | 22.00 | 20.10 | 19.4 |
| Moribundity | 26.00 | 25.30 | 22.90 | 22.8 |

### Example 2—Clear Compositions

Some consumers may prefer a clear pesticidal composition, without accepting any compromises on the effectiveness of the composition. The pesticidal compositions of Examples 5 through 10 vary only in the concentrations of potassium oleate and water. The results in Table 2 show that both incapacitation and kill time increase, as the level of potassium oleate increases.

TABLE 2

| Ingredient (weight | | | | | | |
|---|---|---|---|---|---|---|
| percent) | 5 | 6 | 7 | 8 | 9 | 10 |
| Potassium Oleate | 2.60 | 3.50 | 5.00 | 7.50 | 10.00 | 13.00 |
| Cornmint Oil | 0.55 | 0.55 | 0.55 | 0.55 | 0.55 | 0.55 |
| Rosemary Oil | 2.67 | 2.67 | 2.67 | 2.67 | 2.67 | 2.67 |
| Citronella Oil | 1.88 | 1.88 | 1.88 | 1.88 | 1.88 | 1.88 |
| Cedarwood Oil Texas | 0.53 | 0.53 | 0.53 | 0.53 | 0.53 | 0.53 |
| Thyme Oil | 0.91 | 0.91 | 0.91 | 0.91 | 0.91 | 0.91 |
| Spearmint Oil | 0.06 | 0.06 | 0.06 | 0.06 | 0.06 | 0.06 |
| Isopropyl Alcohol | 20.00 | 20.00 | 20.00 | 20.00 | 20.00 | 20.00 |
| Anhydrous | | | | | | |
| Glycerin | 2.50 | 2.50 | 2.50 | 2.50 | 2.50 | 2.50 |
| DI Water | 66.73 | 65.83 | 64.33 | 61.83 | 59.33 | 56.33 |
| Potassium Citrate | 0.92 | 0.92 | 0.92 | 0.92 | 0.92 | 0.92 |
| Sodium Bicarbonate | 0.55 | 0.55 | 0.55 | 0.55 | 0.55 | 0.55 |
| Potassium Sorbate | 0.10 | 0.10 | 0.10 | 0.10 | 0.10 | 0.10 |
| Incapacitation (seconds) | 18.60 | 20.90 | Not | 23.25 | Not | 24.03 |
| | | | Tested | | Tested | |
| Moribundity (seconds) | 22.40 | 26.50 | Not | 25.50 | Not | 28.35 |
| | | | Tested | | Tested | |
| Clarity¹ | Hazy | Clear | Clear | Clear | Clear | Clear |
| Number of phases¹ | 1 | 1 | 1 | 1 | 1 | 1 |

¹Determined via visual observation of composition at 23° C., where a single-phase composition is stable.

### Example 3—Sodium Bicarbonate

The pesticidal compositions of Examples 11 and 12 vary only in the concentrations of sodium bicarbonate and water. The results in Table 3 show that the addition of sodium bicarbonate reduces both incapacitation and kill time.

TABLE 3

| Ingredient (weight | | |
|---|---|---|
| percent) | 11 | 12 |
| Potassium Oleate | 2.60 | 2.60 |
| Cornmint Oil | 0.55 | 0.55 |
| Citronella Oil | 1.88 | 1.88 |
| Rosemary Oil | 2.67 | 2.67 |
| Thyme Oil | 0.91 | 0.91 |
| Spearmint Oil | 0.057 | 0.057 |
| Cedarwood Oil Texas | 0.53 | 0.53 |
| Isopropyl Alcohol | 20.0 | 20.0 |
| Anhydrous | | |
| Glycerin | 2.50 | 2.50 |
| DI Water | 67.28 | 66.73 |
| Potassium Citrate | 0.92 | 0.92 |
| Sodium Bicarbonate | 0.00 | 0.55 |
| Potassium Sorbate | 0.10 | 0.10 |
| Incapacitation (seconds) | 19.4 | 18.0 |
| Moribundity (seconds) | 22.8 | 20.6 |

### Example 4—Formulation Examples

Tables 4 and 10 include a range of possible formulations according to the disclosure. Tables 5-9 include a range of possible formulations according to the disclosure, as well as incapacitation time and moribundity time data for each of the formulations.

TABLE 4

| | 13 | 14 | 15 | 16 | 17 | 18 | 19 | 20 |
|---|---|---|---|---|---|---|---|---|
| Water | 68.38 | 68.33 | 68.36 | 68.38 | 70.30 | 63.93 | 64.88 | 63.93 |
| Isopropyl | 20.00 | 20.00 | 20.00 | 20.00 | 20.00 | 20.00 | 20.00 | 20.00 |
| Alcohol | | | | | | | | |
| Anhydrous | | | | | | | | |
| Clove Oil | 0.00 | 0.00 | 0.00 | 0.00 | 0.01 | 0.00 | 0.00 | 0.00 |
| Cornmint Oil | 0.85 | 2.50 | 0.55 | 0.00 | 0.55 | 0.11 | 0.00 | 0.11 |
| Rosemary Oil | 4.10 | 2.50 | 2.67 | 0.00 | 1.37 | 0.53 | 0.00 | 0.53 |
| Citronella Oil | 0.00 | 0.00 | 1.00 | 1.95 | 0.09 | 0.38 | 2.60 | 0.38 |
| Cedarwood Oil | 0.00 | 0.00 | 0.04 | 0.00 | 0.04 | 0.11 | 0.00 | 0.11 |
| (Texas) | | | | | | | | |
| Thyme Oil | 0.00 | 0.00 | 0.65 | 0.00 | 0.91 | 0.18 | 0.00 | 0.18 |
| Spearmint Oil | 0.00 | 0.00 | 0.06 | 3.00 | 0.06 | 0.01 | 4.00 | 0.01 |
| Potassium | 2.60 | 2.60 | 2.60 | 2.60 | 2.60 | 2.60 | 5.00 | 2.60 |
| Oleate | | | | | | | | |
| Glycerin | 2.50 | 2.50 | 2.50 | 2.50 | 2.50 | 5.00 | 2.50 | 5.00 |
| Citrate salt | 0.92 | 0.92 | 0.92 | 0.92 | 0.92 | 3.00 | 0.92 | 3.00 |
| Potassium | 0.10 | 0.10 | 0.10 | 0.10 | 0.10 | 1.00 | 0.10 | 1.00 |
| Sorbate | | | | | | | | |
| Xanthan gum | 0.00 | 0.00 | 0.00 | 0.00 | 0.00 | 0.15 | 0.00 | 0.15 |
| Sodium | 0.55 | 0.55 | 0.55 | 0.55 | 0.55 | 1.00 | 0.00 | 1.00 |
| Bicarbonate | | | | | | | | |
| Ethyl Lactate | 0.00 | 0.00 | 0.00 | 0.00 | 0.00 | 2.00 | 0.00 | 2.00 |
| Ultramarine | 0.00 | 0.00 | 0.00 | 0.00 | 0.00 | 0.00 | 0.01 | 0 |
| Blue | | | | | | | | |

TABLE 5

| | 21 | 22 | 23 | 24 | 25 | 26 | 27 | 28 | 29 | 30 |
|---|---|---|---|---|---|---|---|---|---|---|
| Potassium Oleate | 2.60 | 2.60 | 2.60 | 2.60 | 2.60 | 2.60 | 2.60 | 2.60 | 2.60 | 2.60 |
| Clove Oil | 0.00 | 0.01 | 0.26 | 0.51 | 0.51 | 0.51 | 0.51 | 0.01 | 0.26 | 0.51 |
| Cornmint Oil | 0.55 | 0.01 | 0.55 | 0.55 | 0.55 | 0.55 | 0.01 | 0.55 | 0.55 | 0.01 |
| Citronella Oil | 1.88 | 0.09 | 1.75 | 3.42 | 3.42 | 0.09 | 0.09 | 3.42 | 3.42 | 0.09 |
| Rosemary Oil | 2.67 | 2.67 | 1.37 | 2.67 | 0.07 | 1.37 | 2.67 | 2.67 | 0.07 | 0.07 |
| Thyme Oil | 0.91 | 0.91 | 0.47 | 0.47 | 0.47 | 0.02 | 0.47 | 0.91 | 0.91 | 0.02 |
| Spearmint Oil | 0.06 | 2.24 | 2.24 | 0.06 | 2.24 | 1.15 | 0.06 | 0.06 | 1.15 | 2.24 |
| Cedarwood Oil Texas | 0.53 | 1.60 | 1.60 | 0.04 | 0.82 | 0.04 | 1.60 | 1.60 | 0.04 | 1.60 |
| Isopropyl Alcohol | 20.00 | 20.00 | 20.00 | 20.00 | 20.00 | 20.00 | 20.00 | 20.00 | 20.00 | 20.00 |
| Anhydrous | | | | | | | | | | |
| Glycerin | 2.50 | 2.50 | 2.50 | 2.50 | 2.50 | 2.50 | 2.50 | 2.50 | 2.50 | 2.50 |
| DI Water | 66.35 | 66.35 | 65.64 | 66.17 | 65.81 | 70.15 | 68.48 | 64.66 | 67.48 | 69.34 |
| Potassium Citrate | 0.92 | 0.92 | 0.92 | 0.92 | 0.92 | 0.92 | 0.92 | 0.92 | 0.92 | 0.92 |
| Potassium Sorbate | 0.10 | 0.10 | 0.10 | 0.10 | 0.10 | 0.10 | 0.10 | 0.10 | 0.10 | 0.10 |
| Incapacitation (seconds) | 16.9 | 21.1 | 14.6 | 16.2 | 17.8 | 18.2 | 21.9 | 15.2 | 14.5 | 20.3 |
| Moribundity (seconds) | 20.9 | 28.7 | 21.4 | 21.8 | 23.2 | 23.0 | 26.7 | 22.5 | 22.0 | 27.4 |

TABLE 6

| | 31 | 32 | 33 | 34 | 35 | 36 | 37 | 38 | 39 | 40 |
|---|---|---|---|---|---|---|---|---|---|---|
| Potassium Oleate | 2.60 | 2.60 | 2.60 | 2.60 | 2.60 | 2.60 | 2.60 | 2.60 | 2.60 | 2.60 |
| Clove Oil | 0.51 | 0.01 | 0.01 | 0.51 | 0.51 | 0.51 | 0.51 | 0.51 | 0.26 | 0.01 |
| Cornmint Oil | 0.28 | 0.28 | 0.55 | 0.01 | 0.01 | 0.01 | 0.55 | 0.55 | 0.01 | 0.28 |
| Citronella Oil | 3.42 | 3.42 | 1.75 | 0.09 | 0.09 | 3.42 | 0.09 | 0.09 | 3.42 | 1.75 |
| Rosemary Oil | 2.67 | 1.37 | 0.07 | 2.67 | 0.07 | 2.67 | 0.07 | 2.67 | 0.07 | 1.37 |
| Thyme Oil | 0.02 | 0.91 | 0.02 | 0.47 | 0.91 | 0.91 | 0.91 | 0.91 | 0.47 | 0.47 |
| Spearmint Oil | 1.15 | 2.24 | 1.15 | 2.24 | 1.15 | 2.24 | 0.06 | 2.24 | 1.15 | 1.15 |
| Cedarwood Oil Texas | 1.60 | 0.82 | 0.82 | 0.04 | 0.04 | 1.60 | 1.60 | 0.82 | 0.82 | 0.82 |
| Isopropyl Alcohol | 20.00 | 20.00 | 20.00 | 20.00 | 20.00 | 20.00 | 20.00 | 20.00 | 20.00 | 20.00 |
| Anhydrous | | | | | | | | | | |
| Glycerin | 2.50 | 2.50 | 2.50 | 2.50 | 2.50 | 2.50 | 2.50 | 2.50 | 2.50 | 2.50 |
| DI Water | 64.23 | 64.83 | 69.50 | 67.85 | 71.10 | 62.52 | 70.10 | 66.09 | 67.68 | 68.03 |
| Potassium Citrate | 0.92 | 0.92 | 0.92 | 0.92 | 0.92 | 0.92 | 0.92 | 0.92 | 0.92 | 0.92 |
| Potassium Sorbate | 0.10 | 0.10 | 0.10 | 0.10 | 0.10 | 0.10 | 0.10 | 0.10 | 0.10 | 0.10 |
| Incapacitation (seconds) | 18.0 | 15.8 | 21.0 | 19.9 | 26.7 | 17.3 | 18.0 | 18.7 | 19.8 | 18.0 |
| Moribundity (seconds) | 23.8 | 20.2 | 27.5 | 25.4 | 32.5 | 23.8 | 26.0 | 25.7 | 26.5 | 24.1 |

TABLE 7

| | 41 | 42 | 43 | 44 | 45 | 46 | 47 | 48 | 49 | 50 |
|---|---|---|---|---|---|---|---|---|---|---|
| Potassium Oleate | 2.60 | 2.60 | 2.60 | 2.60 | 2.60 | 2.60 | 2.60 | 2.60 | 2.60 | 2.60 |
| Clove Oil | 0.01 | 0.01 | 0.26 | 0.26 | 0.26 | 0.51 | 0.01 | 0.01 | 0.26 | 0.01 |
| Cornmint Oil | 0.28 | 0.55 | 0.28 | 0.55 | 0.01 | 0.01 | 0.55 | 0.55 | 0.28 | 0.01 |
| Citronella Oil | 3.42 | 0.09 | 1.75 | 3.42 | 1.75 | 0.09 | 0.09 | 3.42 | 1.75 | 3.42 |
| Rosemary Oil | 0.07 | 1.37 | 1.37 | 1.37 | 2.67 | 0.07 | 0.07 | 2.67 | 2.67 | 2.67 |
| Thyme Oil | 0.02 | 0.91 | 0.47 | 0.02 | 0.02 | 0.02 | 0.91 | 0.47 | 0.47 | 0.02 |
| Spearmint Oil | 2.24 | 0.06 | 1.15 | 0.06 | 2.24 | 0.06 | 2.24 | 2.24 | 1.15 | 0.06 |
| Cedarwood Oil Texas | 1.60 | 0.04 | 1.60 | 0.82 | 0.82 | 0.04 | 1.60 | 0.04 | 0.82 | 1.60 |
| Isopropyl Alcohol | 20.00 | 20.00 | 20.00 | 20.00 | 20.00 | 20.00 | 20.00 | 20.00 | 20.00 | 20.00 |
| Anhydrous | | | | | | | | | | |
| Glycerin | 2.50 | 2.50 | 2.50 | 2.50 | 2.50 | 2.50 | 2.50 | 2.50 | 2.50 | 2.50 |
| DI Water | 66.23 | 70.85 | 67.00 | 67.38 | 66.10 | 73.08 | 68.41 | 64.48 | 66.48 | 66.08 |
| Potassium Citrate | 0.92 | 0.92 | 0.92 | 0.92 | 0.92 | 0.92 | 0.92 | 0.92 | 0.92 | 0.92 |
| Potassium Sorbate | 0.10 | 0.10 | 0.10 | 0.10 | 0.10 | 0.10 | 0.10 | 0.10 | 0.10 | 0.10 |
| Incapacitation (seconds) | 18.5 | 25.8 | 22.0 | 26.5 | 16.3 | 22.5 | 23.8 | 14.9 | 15.7 | 18.9 |
| Moribundity (seconds) | 26.0 | 32.5 | 31.9 | 29.7 | 21.8 | 29.5 | 32.2 | 19.4 | 19.5 | 23.2 |

TABLE 8

| | 51 | 52 | 53 | 54 | 55 | 56 | 57 | 58 | 59 | 60 |
|---|---|---|---|---|---|---|---|---|---|---|
| Potassium Oleate | 2.60 | 2.60 | 2.60 | 2.60 | 2.60 | 2.60 | 2.60 | 2.60 | 2.60 | 2.60 |
| Clove Oil | 0.51 | 0.51 | 0.26 | 0.01 | 0.26 | 0.01 | 0.01 | 0.26 | 0.01 | 0.26 |
| Cornmint Oil | 0.28 | 0.01 | 0.28 | 0.01 | 0.01 | 0.28 | 0.01 | 0.28 | 0.55 | 0.28 |
| Citronella Oil | 1.75 | 3.42 | 1.75 | 1.75 | 3.42 | 3.42 | 0.09 | 0.09 | 0.09 | 1.75 |
| Rosemary Oil | 1.37 | 0.07 | 0.07 | 0.07 | 2.67 | 0.07 | 1.37 | 1.37 | 2.67 | 2.67 |
| Thyme Oil | 0.91 | 0.91 | 0.02 | 0.91 | 0.91 | 0.47 | 0.02 | 0.47 | 0.02 | 0.02 |
| Geraniol | | | | | | | | | | |
| Spearmint Oil | 0.06 | 0.06 | 0.06 | 2.24 | 0.06 | 0.06 | 1.15 | 1.15 | 0.06 | 0.06 |
| Cedarwood Oil Texas | 0.82 | 1.60 | 1.60 | 0.04 | 0.04 | 0.04 | 0.04 | 0.82 | 1.60 | 0.04 |
| Isopropyl Alcohol | 20.00 | 20.00 | 20.00 | 20.00 | 20.00 | 20.00 | 20.00 | 20.00 | 20.00 | 20.00 |
| Anhydrous | | | | | | | | | | |
| Glycerin | 2.50 | 2.50 | 2.50 | 2.50 | 2.50 | 2.50 | 2.50 | 2.50 | 2.50 | 2.50 |
| DI Water | 68.18 | 67.30 | 69.84 | 68.84 | 66.51 | 69.53 | 71.18 | 69.45 | 68.88 | 68.79 |
| Potassium Citrate | 0.92 | 0.92 | 0.92 | 0.92 | 0.92 | 0.92 | 0.92 | 0.92 | 0.92 | 0.92 |
| Potassium Sorbate | 0.10 | 0.10 | 0.10 | 0.10 | 0.10 | 0.10 | 0.10 | 0.10 | 0.10 | 0.10 |
| Incapacitation (seconds) | 17.7 | 23.8 | 21.2 | 18.0 | 17.3 | 22.3 | 23.2 | 23.0 | 17.1 | 18.1 |
| Moribundity (seconds) | 22.0 | 28.8 | 27.8 | 22.2 | 22.8 | 29.0 | 27.2 | 29.9 | 21.8 | 23.0 |

TABLE 9

| | 61 | 62 | 63 | 64 | 65 | 66 | 67 | 68 | 69 | 70 |
|---|---|---|---|---|---|---|---|---|---|---|
| Potassium Oleate | 2.60 | 2.60 | 2.60 | 2.60 | 2.60 | 2.60 | 2.60 | 2.60 | 2.60 | 2.60 |
| Clove Oil | 0.51 | 0.26 | 0.51 | 0.00 | 0.00 | 0.00 | 0.00 | 0.00 | 0.013 | 0.00 |
| Cornmint Oil | 0.01 | 0.28 | 0.00 | 0.00 | 0.00 | 0.00 | 0.00 | 0.00 | 0.014 | 0.55 |
| Citronella Oil | 3.42 | 0.09 | 0.00 | 3.42 | 0.00 | 0.00 | 0.00 | 0.00 | 0.087 | 0.00 |
| Rosemary Oil | 1.37 | 0.07 | 0.00 | 0.00 | 2.67 | 0.00 | 0.00 | 0.00 | 0.068 | 0.00 |
| Thyme Oil | 0.02 | 0.02 | 0.00 | 0.00 | 0.00 | 0.91 | 0.00 | 0.00 | 0.91 | 0.00 |
| Spearmint Oil | 2.24 | 2.24 | 0.00 | 0.00 | 0.00 | 0.00 | 2.24 | 0.00 | 0.057 | 0.00 |
| Cedarwood Oil Texas | 0.04 | 0.04 | 0.00 | 0.00 | 0.00 | 0.00 | 0.00 | 1.60 | 1.6 | 0.00 |
| Isopropyl Alcohol | 20.00 | 20.00 | 20.00 | 20.00 | 20.00 | 20.00 | 20.00 | 20.00 | 20.0 | 20.0 |
| Anhydrous | | | | | | | | | | |
| Glycerin | 2.50 | 2.50 | 2.50 | 2.50 | 2.50 | 2.50 | 2.50 | 2.50 | 2.50 | 2.50 |
| DI Water | 66.26 | 70.88 | 73.37 | 70.46 | 71.21 | 72.97 | 71.64 | 72.28 | 71.1 | 73.3 |
| Potassium Citrate | 0.92 | 0.92 | 0.92 | 0.92 | 0.92 | 0.92 | 0.92 | 0.92 | 0.92 | 0.92 |
| Potassium Sorbate | 0.10 | 0.10 | 0.10 | 0.10 | 0.10 | 0.10 | 0.10 | 0.10 | 0.10 | 0.10 |
| Incapacitation (seconds) | 18.8 | 19.5 | 24.6 | 17.6 | 19.6 | 20.5 | 18.0 | 28.4 | 31.0 | 33.0 |
| Moribundity (seconds) | 23.6 | 25.1 | 29.4 | 24.8 | 26.8 | 28.6 | 24.0 | 34.8 | 37.4 | 40.4 |

TABLE 10

| | 71 | 72 | 73 | 74 | 75 | 76 | 77 |
|---|---|---|---|---|---|---|---|
| Potassium Oleate | 1.00 | 1.00 | 1.00 | 1.00 | 1.00 | 2.60 | 1.00 |
| Clove Oil | 0 | 0 | 0 | 0 | 0 | 0 | 0 |
| Cornmint Oil | 1.80 | 0.90 | 0 | 0.60 | 0.30 | 0 | 0.714 |
| Citronella Oil | 0 | 0 | 0 | 0 | 0 | 0 | 0 |
| Rosemary Oil | 0 | 0.90 | 0 | 0 | 0.30 | 0 | 0.714 |
| Thyme Oil | 0 | 0 | 0 | 0 | 0 | 0 | 0 |
| Geraniol | 0 | 0 | 1.40 | 1.00 | 1.00 | 3.50 | 0 |
| Spearmint Oil | 0 | 0 | 0 | 0 | 0 | 0 | 0 |
| Cedarwood Oil | 0 | 0 | 0 | 0 | 0 | 0 | 0 |
| Texas | | | | | | | |
| Isopropyl | 18.0 | 18.0 | 18.0 | 18.0 | 18.0 | 18.0 | 18.8 |
| Alcohol | | | | | | | |
| Anhydrous | | | | | | | |
| Glycerin | 2.5 | 2.5 | 2.5 | 2.5 | 2.5 | 2.5 | 2.5 |
| DI Water | Qs | Qs | Qs | Qs | Qs | Qs | Qs |
| Potassium Citrate | 0.92 | 0.92 | 0.92 | 0.92 | 0.92 | 0.92 | 0.92 |
| Potassium Sorbate | 0.10 | 0.10 | 0.10 | 0.10 | 0.10 | 0.10 | 0.40 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A pesticidal composition comprising:
a. from about 40% to about 95% by weight of the composition of water;
b. from about 0.01% to about 15% by weight of the composition of potassium oleate;
c. from about 1% to about 45% by weight of the composition of isopropyl alcohol;
d. optionally, from about 0.01% to about 15% by weight of the composition of sodium bicarbonate; and
e. optionally, from about 0.01% to about 1% by weight of the composition of citric acid anhydrous, citric acid monohydrate, or a combination thereof;
f. from about 1% to about 15% by weight of the composition of one or more active ingredients selected from the group consisting of corn mint oil, peppermint oil, spearmint oil, rosemary oil, thyme oil, citronella oil, clove oil, cedarwood oil, cinnamon oil, geranium oil, eugenol, 2-phenylethyl propionate, menthol, menthone, thymol, carvone, camphor, methyl salicylate, p-cymene, linalool, geraniol, cinnamyl acetate, cinnamic alcohol, cinnamaldehyde, citronellol, eucalyptol/1,8-cineole, alpha-pinene, bornyl acetate, gamma-terpinene, and combinations thereof;
wherein the composition has a pH of from about 4.5 to about 11.0.

2. The pesticidal composition of claim 1, wherein the composition is clear.

3. The pesticidal composition of claim 1, wherein the composition is an oil-in-water emulsion.

4. The pesticidal composition of claim 1, wherein the composition is substantially free of sodium lauryl sulfate.

5. The pesticidal composition of claim 1, wherein the composition is packaged in a clear container.

6. The pesticidal composition of claim 1, wherein the composition further comprises from about 0.01% to about 0.5% of tocopherol.

7. The pesticidal composition of claim 1, wherein the composition is substantially free of mineral oil.

8. The pesticidal composition of claim 1, wherein the composition comprises only food grade ingredients.

9. The pesticidal composition of claim 1, wherein the composition comprises from about 0.5% to about 7% by weight of the composition of rosemary oil.

10. The pesticidal composition of claim 1, wherein the composition comprises from about 0.5% to about 7% by weight of the composition of corn mint oil.

11. The pesticidal composition of claim 1, wherein the composition comprises from about 0.5% to about 7% by weight of the composition of spearmint oil.

12. The pesticidal composition of claim 1, wherein the composition comprises from about 0.5% to about 7% by weight of the composition of thyme oil.

13. The pesticidal composition of claim 1, wherein the composition comprises from about 0.5% to about 7% by weight of the composition of citronella oil.

14. The pesticidal composition of claim 1, wherein the composition comprises from about 0.5% to about 7% by weight of the composition of cedarwood oil.

15. The pesticidal composition of claim 1, wherein the composition further comprises from about 0.001% to about 1% by weight of the composition of a colorant selected from the group consisting of ultramarine blue, red cabbage dye, beet dye, carrot dye, chlorophyll, and mixtures thereof.

16. The pesticidal composition of claim 1, wherein the composition further comprises from about 0.1% to about 7.5% by weight of the composition of a polysaccharide.

17. The pesticidal composition of claim 1, wherein the composition has a turbidity less than about 20 NTU and greater than or equal to 0 NTU.

18. The pesticidal composition of claim 1, wherein the composition has a b* value of about 0 to about 4.

19. A method of controlling an arthropod pest comprising: i) contacting the arthropod pest with the pesticidal composition according to claim 1; ii) optionally, wiping excess composition from an adjacent surface.
